(19) United States
(12) Patent Application Publication
(10) Pub. No.: US 2020/0133684 A1
(43) Pub. Date: Apr. 30, 2020

(54) AUTOMATED SYSTEM FOR RATING EMPLOYER SCREENING PRACTICES AND CORPORATE MANAGEMENT

(71) Applicants: Thomas P. BOLES, (US); Christopher L. ROTHWELL, (US)

(72) Inventors: Thomas P. BOLES, Clarks Summit, PA (US); Christopher L. ROTHWELL, South Abington Township, PA (US)

(21) Appl. No.: 16/711,219

(22) Filed: Dec. 11, 2019

Related U.S. Application Data
(63) Continuation-in-part of application No. 16/010,382, filed on Jun. 15, 2018.
Application No. 16/010,382 is a division of application No. 14/799,459, filed on Jul. 14, 2015, now abandoned.
(60) Provisional application No. 62/024,816, filed on Jul. 15, 2014.

(51) Int. Cl. G06F 9/4401; G06Q 30/00; G06F 9/50; G06F 9/455

(52) U.S. Cl. CPC G06F 9/4408; G06Q 30/018; G06F 9/5061; G06F 2009/45575; G06F 9/4401; G06F 9/45558; G06F 9/4416; G06F 9/45533

(57) ABSTRACT

A novel automated system develops a uniform rating of screening practices of organizations/industry entities (IEs) in a given industry. The uniform rating is based upon objective employee screening practices during pre-employment screening. The system allows IEs to view employee screening parameters of their own records stored on the system, add information and update the values of these employee screening parameters. These records are also made available to all users. The system creates weighting factors based upon the relative importance of each employee screening parameters then creates the rating based upon a combination of the weighted employee screening practices used by an IE. This rating reflects an estimate of the completeness, or thoroughness of the employment screening practices of each IE which has a direct effect upon the quality of the employees hired and ultimately upon the quality of the products produced by these employees or the services rendered.

### CROSS REFERENCE TO RELATED APPLICATIONS

This patent application is a Continuation-In-Part (CIP) of U.S. patent application Ser. No. 16/010,382 filed Jun. 15, 2018 (C3GR-1501DIV) titled “Automated System for Rating Employee Screening Practices and Corporate Management”; which is a Divisional U.S. patent application Ser. No. 14/799,459 filed Jul. 14, 2015 (C3GR-1501) titled “Automated System for Rating Employee Screening Practices and Corporate Management”; that claims the benefit of U.S. Provisional patent application No. 62/024,846 filed Jul. 15, 2014 (C3GR-1501PR) titled “An Automated system for Rating Employee Screening Practices” and all by Inventors Thomas P. Boles and Christopher L. Rothwell.

### FIELD

This application is directed toward an automated system for collecting and rating information about employer screening practices and optionally, corporate management and making the information available to the public, and more particularly to an automated system for collecting and rating information about employer screening practices and corporate management and generating uniform objective ratings and making the information and ratings available to the public.

### BACKGROUND

In any job performed by human workers, it is important for the job to be done effectively and meet the expected requirements. These jobs may involve producing products or providing services. Potential consumers weigh the positive attributes of a product or service against any negative attributes when determining which to select.

Positive attributes of a product include how well it performs its expected duties. The positive attributes of a service include how well the company or employee performs the expected services.

The negative attributes of a product or service may include any harm or injury the consumers experience from products or services. An injury caused to the end consumer by a product could be a faulty braking system that causes a car to crash and injure the driver. An injury caused by a service could be physical abuse to an elderly client by a home healthcare worker. As indicated, the character of the employee has a large effect upon the products/services provided and the related harm done.

Therefore, when a potential consumer is looking for a product or service, they weigh the negative attributes of the product or service against the positive attributes. In order to perform this weighing, the consumer needs information and assistance in choosing the correct product or service.

There currently are rating systems which provide ratings (which may be scores) of how well products perform; however, they give little or no information on the negative attributes caused by employees producing the products. Similarly, there are rating systems which rate services, but provide little information on the employees providing the services. If any such information is provided, it usually does not relate to the same parameters. Therefore, currently it is difficult to rate companies providing products or services based upon the same parameters.

Since management has control over the workers and how they behave, many times studying the management of a company can provide information of potential problems.

Currently, there is a need for an automated system that acquires uniform information from selected companies indicating how the companies select employees that produce their products or provide their services and analyzes management to produce a uniform rating for these companies and provide the information and ratings to the public.

### SUMMARY

The current system man be embodied as a system for selecting an industry entity (IE) based upon rating selected screening practices (SPs) of the IEs by a remote user employing a user communication device.

The system includes a processor, and the user communication device is operably connected to the processor.

The system also includes an IE storage device that can be accessed by a remote user through the user communication device and store, through the processor, values of employer's screening practices of a plurality of Industry Entities (IEs), a parameter storage device remotely accessible by the remote user through the user communication device having a prestored list of employer's screening practices (SPs) to be used by the processor to determine a rating for a selected industry, and a weighting factor storage device capable of storing weighting factors (WFs) that each indicate an importance of each selected screening practice (SP).

The processor is coupled to the IE storage device, the parameter storage device 170, and the weighting factor storage device, wherein the processor includes a set of instructions that when executed, acquire a plurality of selected employer's screening practices (SPs) from the parameter storage device; acquire values of the plurality of selected employer's screening practices from the IE storage device, acquire corresponding weighting factors (WFs) from the weighting factor storage device; determine a rating for each IE 3 by summing each selected employer's screening practice (SP) value multiplied by its corresponding weighting factor (WF), electronically transmitting the rating to, and displaying the rating on the user communication device of the remote user; and selecting, by the remote user, an IE based upon the rating.

The current system may be embodied as a system for aiding a remote user in selecting an industry entity (IE) to employ based upon rating of the thoroughness of the screening practices (SPs) of IEs having a user communication device capable of receiving user input and communicating with remote computing devices, a processor capable of communicating with the user communication device, a parameter storage device having prestored selected screening practices (SPs) relevant to the current industry;

a weighting factor storage device capable of storing weighting factors (WFs) indicative of the importance of each of the selected screening practices (SPs), an IE storage device capable of storing values for each of the selected screening practices (SPs) for each IE.

The processor includes a set of instructions that when executed receives the selected screening practices (SPs) from the parameter storage device, the corresponding values for each selected screening practice (SP) from the IE storage, and the weighting factors (WFs) for each of the selected screening practice (SP) from the weighting factor storage device, multiplies the value for each screening practice (SP) by its corresponding weighting factor (WF) to create products for all selected screening practices (SPs), and sums all products to create a rating for each IE, and provides the ratings to the user communication device to display to the user aiding the user in selecting and hiring an IE.

The current invention may also be embodied as a system to objectively create and publish a rating of employment screening practices (SPs) of industry entities (IE) to a user aiding the user in hiring an IE, having a parameter storage device having a plurality of pre-stored employment screening practices (SPs) which are relevant to a given industry, a weighting factor storage device for storing weighting factors (WFs) each indicating a relative importance with each associated selected screening practice (SPs), an IE storage device for storing a value for each selected screening practices (SPs) indicating those screening practices (SPs) that are currently being performed by each of the IEs;

industry entity communication devices coupled to the controller, which communicate information between Industry Entities (IEs) and the IE storage device through the controller, wherein the controller multiplies each of the (WFs) in the weighting factor storage device by the values of their corresponding (SPs) in parameter storage device and sums these products for all selected screening practices (SPs) to result in the rating of each IE that is stored in the IE storage device, that is used by user to hire an IE.

The current system may be embodied as a system for providing information regarding employee screening practices of industry entities (IEs) 3 having an IE storage 110 that is remotely accessible and to store values of a plurality of parameters such as screening practices of IEs 3. It also includes a parameter storage 130 having a list of screening practices along with their values, referred to as a “profile”, to be used to determine a rating (a score) for a selected industry, a weighting factor storage 160 that stores weighting factors that each correspond to a selected screening practice indicating their relative impact upon a rating, a controller 210 coupled to the IE storage 110, the parameter storage 130, and the weighting factor storage 160. The controller 210 acquires the selected screening practices from the parameter storage 130, acquire values of the selected screening practices from IE storage 110, acquire corresponding weighting parameters from the weighting factor storage 160, create a rating equation for the selected industry employing the selected screening practices and their corresponding weighting factors, and create a rating for at least one IE of the selected industry having values for the selected screening practices by applying the rating equation to the acquired values for each IE.

The current system may also be embodied as a system for creating a rating of the employee screening practices of industry entities (IEs) 3 that has an IE storage 110 of having prestored screening practices that have values indicating a status of each screening practice, weighting factor storage 160 having prestored weighting factors for at least one of the screening practices, a controller 210 which creates a rating based upon the values of the screening practices and the weighting factors of each screening practice.

It may also be embodied as a method of rating the employee screening practices of industry entities (IEs) 3 in a given industry having the steps of selecting screening practice 340 that are relevant to the industry, determining a relative weighting factor 350 corresponding to at least one of the selected screening practices based upon its expected impact upon an employee's performance after employment. An automated system 100 is provided to allow the IEs 3 to enter values for the selected screening practices relating to it and calculate ratings 380 from a combination of the values of the selected screening practices and their corresponding weighting factors.

The method of current invention may also include the steps of identifying the executive management of an IE from at least one of a) information entered by the IEs, b) a corporate database, and c) a corporate information service. Then choosing a target manager to analyze from the executive management found and obtaining at least one of a) criminal background information, b) civil background information, and c) past corporate performance for the target manager. The obtained information is adjusted for at least one of the a) severity of a criminal offense, b) age of the information obtained, and c) corporate size. A rating based upon the adjusted information may optionally be created. The information obtained, and optionally the ratings are made available to a predetermined group. Further, the past corporate performance of a target manager may be adjusted by the target manager's level in the company. The rating may also be based upon the ratings of a plurality of target managers.

### BRIEF DESCRIPTION OF THE DRAWINGS

It will be appreciated that the illustrated boundaries of elements in the drawings represent only one example of the boundaries. One skilled in the art will appreciate that a single element may be designed as multiple elements or that multiple elements may be designed as a single element. An element shown as an internal feature may be implemented as an external feature and vice versa.

Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1 shows a system diagram of an automated system according to one embodiment of the current invention.

FIG. 2 is a flowchart illustrating the steps of a method of rating the employee screening practices of industry entities (IEs).

FIG. 3 is a more detailed breakdown of the step of FIG. 2 of selecting screening practices for a selected industry.

FIG. 4 is a more detailed breakdown of the step of FIG. 2 of determining a relative weighting factor for each selected screening practice.

FIG. 5 is a more detailed breakdown of the step of FIG. 2 of adding/modifying values for a selected screening practice of FIG. 2.

FIG. 6 shows a system diagram of an automated system according to another embodiment of the current invention.

FIGS. 7A-7E together are an example of an Assessment and Rating Report which can be generated by the current system.

### DETAILED DESCRIPTION

As indicated above, consumers would like information and assistance when selecting products and services. A product produced by an employee that accurately follows the rules and training, and is conscientious about his/her work, produces a product that is more likely to perform its expected function than one produced by an employee that does not follow the rules and training and is not conscientious about his/her work.

Similarly, services provided by an employee that accurately follows the rules and training and is conscientious about his/her work are more likely to be performed as expected. Whereas services provided by an employee that does not follow the rules and training, and is not conscientious about his/her work, are more likely to result in substandard services, or damage the consumer.

We will refer to the expected overall repeatable behavior of the employee as their “character”.

The character of the employee is especially relevant in home healthcare companies (HHCs). A more detailed description of the HHCs will provide specific examples of how the uses and advantages of the current invention are applied to the HHC industry. Even though the current invention will be described in detail here for the HHC industry, please note that the principles described here apply equally to many other industries and may easily be translated to these industries. The spirit of the current invention is asserted to cover not only the HHC industry, but also numerous other industries which screen employees before employment.

### The Population is Rapidly Growing Older

With the current demographics in the U.S., there will be a large increase in the average age of the U.S. population within the next few years. This results in a larger aging population, many of which require assistance in daily living, and some will also require medical care. Those older individuals that require medical care may be admitted to a nursing home. Others may be healthy enough to live on their own but require non-medical assistance in washing, dressing, eating, etc. HHCs provide people to assist these older individuals in their homes. These HHCs employ and train employees (HHC Assistants) to provide care for older individuals. The HHCs then place these HHC Assistants in the homes of the elder persons (consumers).

For these reasons, a person who is tasked with finding an HHC for a loved one will need to have information about the process the HHC employs to hire the HHC Assistant.

There are few rules indicating which information about each HHC should be made available to the public. HHCs tend to advertise their strongest features. They also tend to refrain from advertising any aspects of the HHC that would be considered negative. Therefore, it is difficult to compare HHCs in a uniform manner.

With the large number of HHCs available, the lack of information provided by each of the HHCs and the lack of a uniform system for rating them makes it difficult for a person (decision maker) making the decisions for the elder person to make an informed decision as to which HHC would be best for the elder person.

HHCs must be licensed by state licensing departments in order to operate. Therefore, a decision maker may feel that since the HHCs are licensed, they all would provide the same standard of care and protections for the elder person.

In reality, the state requirements relating to screening of the employee before they are hired are minimal. Many HHCs have found that performing additional tasks to implement additional standards and requirements during pre-employee screening, in addition to those required by the state, result in employees with better character that provide a higher level of care. Therefore, the set of tasks actually performed by the HHCs during the pre-employee screening is a good indicator of the average character (performance during employment) of the employees hired.

Due to the current lack of uniform information available to the decision maker about the employee screening process of each HHC, and the misplaced reliance upon the state licensing requirements, decision makers have inaccurate expectations of the quality of services that each HHC will provide. As used herein, high quality is defined as efficiently providing services in a timely manner that meet or exceed the expectations of proper service of the consumer (elder person in the HHC, for example) with no negative aspects, such as crimes being committed, defrauding of the consumer, or less than respectful attitudes and treatment.

### Less Rigorous Employment Process

Due to the rapid increase in the population of older individuals in the U.S., some HHCs have had a hard time keeping up with demand. In doing so, some have cut corners on their screening of potential employees, the employment verification, background checks, training, oversight, and other tasks performed by the eldercare companies. These have caused problems with the services provided by these HHCs. Due to the less rigorous employee screening practices, HHC employees hired exhibit repeated behavior of being unresponsive, lacking required skills, or not being as diligent as they should be.

Currently, the low unemployment rate has reduced the available labor pool and it is known that companies have stopped performing some drug and/or background checks to be able to fill their open positions. This further emphasizes the need for analyzing employment screening practices and providing objective ratings.

### Potential for Problems

As indicated above, the HHC Assistants are placed in the elder person's home and are generally unsupervised when performing services for the elder person. The HHC Assistants spend many hours in an elder person's home. After working with the same elder person for a while, the HHC Assistant develops intimate knowledge of the person's home, routine, finances, and other personal information. They are usually alone with the elder person and unsupervised. The HHC Assistant may also become familiar with locations where the elder person hides money and valuables, as well as have access to financial information, credit card numbers, etc. These pose significant problems for the HHC. Therefore, it is not surprising that HHC Assistants have abused or otherwise mistreated elder persons, stolen items of value and financial information from the elder person.

### Employee Screening Practices

It was found that the employee screening practices have a significant effect upon the behavior and performance of the employees hired as HHC Assistants. The behavior and performance of the HHC Assistants greatly affects the overall perception of the quality of the HHC. Therefore, the employee screening practices have a predominant effect upon the perceived quality of the HHC overall.

In 2015, Arizona became the first state to require non-medical home health agencies to disclose their background check practices to the public. This is further described in “AZ Law Aims to Protect Seniors From Bad In-home Caregivers”, Arizona Daily Star. Aug. 2, 2015, https://tucson.com/lifestyles/health-med-fit/az-law-aims-to-protect-seniors-from-bad-in-home/article_dd7d0f59-7dbc-52b6-8e01-e00ad53d2e76.html

All terms will be given their common and ordinary meaning unless specifically defined in the specification. In such case, the specific definition should be used in place of the common meaning.

The same reference numbers are intended to represent the same structure, either on the same figure or across different figures.

It is to be appreciated that embodiments of the methods and apparatuses discussed herein are not limited in application to the details of construction and the arrangement of components set forth in the following description or illustrated in the accompanying drawings. The methods and apparatuses discussed herein are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Any references to embodiments or elements or acts of the systems and methods herein referred to in the singular may also embrace embodiments including a plurality of these elements, and any references in plural to any embodiment or element or act herein may also embrace embodiments including only a single element.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the various aspects and embodiments. Any embodiment disclosed herein may be combined with any other embodiment in any manner consistent with the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. Additional features, aspects, examples and embodiments are possible and will be recognized by the person of ordinary skill in the art, given the benefit of this disclosure.

It is also to be appreciated that the phraseology and terminology used herein is for the purpose of description and should not be regarded as limiting. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, and upper and lower are intended for convenience of description, not to limit the present systems and methods or their components to any one positional or spatial orientation.

Also, the decision makers have a great deal of power over the workers and services provided. Therefore, the integrity of the senior, or executive, management is important to the quality of services provided to a person. Therefore, it is highly relevant to analyze the executive management. A manager being analyzed is referred to as a “target manager”.

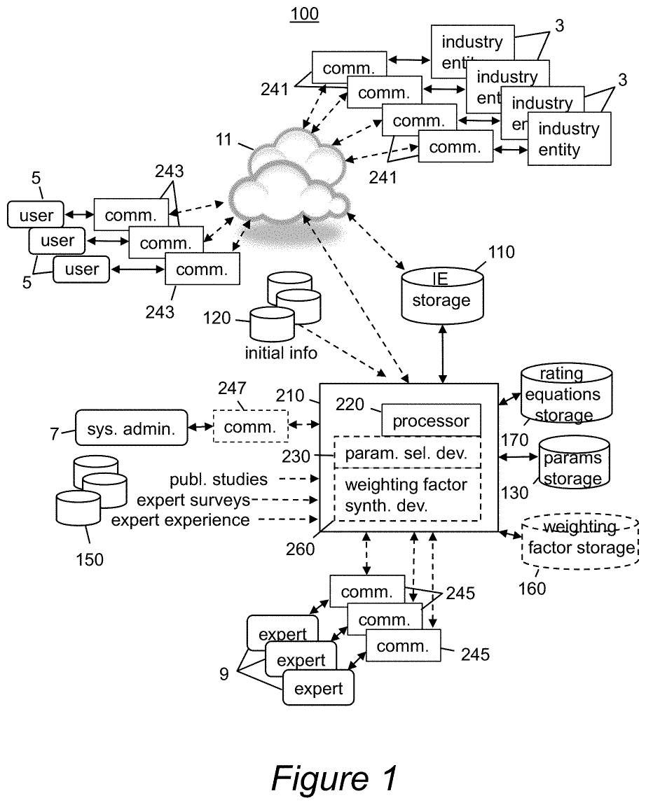

FIG. 1 shows a system diagram of an automated system 100 according to one embodiment of the current invention. The system provides objective information and ratings of the tasks of employee screening practices performed by industry entities (IEs) 3. The IEs 3 may be home health care companies for the home health care industry, or other companies for other industries. This is an on-line system wherein at least part of it is remotely located and remotely accessible. As is shown, IEs 3 communicate through IE communication devices 241 through local area network (LAN), wide area network (WAN), Internet, private network, or other intercomputer connection means (collectively referred to as a “computer network”) 11 to an IE storage 110. The IE storage 110 is the main depository of information of the IEs 3, as will be explained further below.

Users 5 are allowed to access, search, and view, but not modify or delete information on the IE storage 110 using user communication devices 243.

A system administrator 7 communicates directly (or through an optional systems administrator communication device 247) with other elements of system 100 to configure, initialize and otherwise manage the system 100.

### Selecting Screening Practices

The system administrator 7 interacts through a system administrator communication device 247 with a controller 210 to determine a listing of relevant screening practices for at least one industry covered by the current invention. Controller 210 may incorporate a specific device and/or software routines that aid in determining the screening practices to be used. These screening practices differ by industry since certain screening practices may be highly relevant to one industry but not relevant to another. There are various methods of selecting the relevant screening practices for an industry. A few such methods are listed below:
identifying the screening practices common to the leading publications in the industry;
statistically identifying the leading reasons for employee dismissal and identifying the screening practices associated with these reasons;
selecting a group of experts in the industry and polling them for the relevant screening practices, then selecting those screening practices that had been proposed by several experts.

In a simple embodiment, an expert 9 in the industry, acting through a communication device 245, communicates with a controller 210 which may employ a processor 220. In this embodiment, the expert 9 can simply input the screening practices to be used in the rating process. These screening practices can then be stored in the parameter storage 130.

In another embodiment, controller 210 may include a parameter selection device 230 that may receive published studies in the industry relating to screening practices. The parameter selection device 230, controlled by the system administrator 7, searches for relevant screening practices and analyzes them. The most relevant and/or commonly mentioned screening practices will be stored in the parameter storage 130 and used to rate the IEs 3.

The parameter selection device 230 may also search published expert surveys dealing with screening practices. These may be digested to provide the few most commonly mentioned screening practices that will be used for rating the IEs 3.

The parameter selection device 230 may also analyze numerous publications dealing with publications of experts' experience in the field, selecting the most commonly mentioned screening practices that will then be stored in the parameter storage 130 and used in rating the IEs 3 employee screening practices.

In another embodiment it can be arranged that a number of experts 9 log into the automated interactive system 100 through communication device 245. The experts 9 can log in at their leisure over a period of time. The parameter selection device 230 may then interactively send questions to the experts 9 requesting information that would identify screening practices that they believe are relevant. The parameter selection device 230 receives the experts' 9 responses, then selects the most commonly mentioned screening practices for use in determining a rating. These screening practices are then stored in the parameter storage 130.

### Determining Weighting Factors

In a similar manner, one or more experts 9 in the industry can provide input as to the relative impact of each selected screening practice on the quality of the employee hired. In a first embodiment, an expert 9 may simply input his/her weighting of each selected screening practice in the parameter storage 130.

In a more sophisticated embodiment, a weighting factor synthesis device 260 can search published studies in the industry and identify the screening practices mentioned having the greatest impact upon hiring quality employees. The relative number of studies indicating that a given screening practice is important may be used in assigning weighting factors to each screening practice.

In another embodiment, a weighting factor synthesis device 260 can search expert surveys in the industry and identify the screening practices mentioned having the greatest impact upon hiring quality employees. The relative number of surveys indicating that a given screening practice is important may be used in assigning weighting factors to each screening practice.

The system 100 according to one embodiment of the current invention interacts with the IEs 3. It allows the IEs 3 to view the information about themselves that is currently in the IE storage 110 that is being provided to the public. The IEs 3 is allowed to search through the IE storage 110, view records, and provide updated information about its own records in the IE storage 110. The updated information is verified by the system administrator 7. Once it is verified, the information is updated in the IE storage 110.

Table 1 below lists the screening practices selected as relevant for creating a rating (score) of the employee screening practices of a Home Healthcare facility, listed by type. It also indicates the relative weighting factor of each.

TABLE 1

| | WEIGHTING | | |
|---|---|---|---|
| TYPE | FACTOR (WF) | | SCREENING PRACTICE (SP) |
| Employment | 2 | (WF₁) | 1. Employment Eligibility (I9) |
| | | | Verification (SP₁) |
| Employment | 2 | (WF₂) | 2. Employment History Verification (SP₂) |
| Employment | 5 | (WF₃) | 3. Education/Licenses/Credentials |
| | | | Verification (SP₃) |
| Employment | 2 | (WF₄) | 4. Reference Check (SP₄) |
| Employment | 2 | (WF₅) | 5. Social Security Verification (SP₅) |
| Background | 10 | (WF₆) | 6. State Criminal Background Check (SP₆) |
| Background | 10 | (WF₇) | 7. Federal Criminal Background Check |
| | | | (SP₇) |
| Background | 5 | (WF₈) | 8. Civil Lawsuit Check (SP₈) |
| Background | 5 | (WF₉) | 9. Credit History Check (SP₉) |
| Background | 5 | (WF₁₀) | 10. Motor Vehicle Report (SP₁₀) |
| Background | 10 | (WF₁₁) | 11. Child Abuse Check (SP₁₁) |
| Background | 10 | (WF₁₂) | 12. Elder Abuse Check (SP₁₂) |
| Background | 10 | (WF₁₃) | 13. National Sex Offender Check (SP₁₃) |
| Background | 2 | (WF₁₄) | 14. Excluded Parties List System (EPLS) |
| | | | Check (SP₁₄) |
| Background | 2 | (WF₁₅) | 15. List of Excluded Individuals/Entities |
| | | | (LEIE) Check (SP₁₅) |
| Background | 2 | (WF₁₆) | 16. Tuberculosis Testing (SP₁₆) |
| Drug | 8 | (WF₁₇) | 17. Pre-Employment Drug Testing (SP₁₇) |
| Drug | 2 | (WF₁₈) | 18. Post-Injury Drug Testing (SP₁₈) |
| Drug | 4 | (WF₁₉) | 19. Random Drug Testing (SP₁₉) |
| Drug | 2 | (WF₂₀) | 20. Reasonable Suspicion Drug Testing |
| | | | (SP₂₀) |

As shown above, these are grouped into categories of verification of past employment, verification of background, and drug testing. (Other screening practices may be added that are specific to a given company or entity.) Each is listed by their commonly used names and each has their commonly used meanings. The “Employment Eligibility (I9) Verification” is a verification indicating that the person is eligible to work in the US. “Employment History Verification” is a verification that the applicant actually did work for these companies. “Education/Licenses/Credentials Verification” is a check that all of these listed by the applicant were actually received. “Reference Check” requires that each of the references listed by the applicant be verified. Similarly, the remaining employee screening tasks have their common meanings.

### Alternative Methods of Determining Weighting Factors

In still another embodiment, selected screening practices for an industry may be sent to experts in the industry to provide their estimate of the weight each screening practice has upon the process for hiring employees. This survey may then be analyzed using various known statistical methods to create the weighting factors for the selected screening practices. The expert's answers may be averaged, combined to determine a mean, median, or other combination for each screening practice to be used in determining a rating of the thoroughness of the employment process for the IEs.

In still another embodiment, the published studies of various on-line databases 150 may be analyzed to find databases indicating employees that were disciplined or terminated and reasons for their discipline or termination. The controller 210/processor 220 may find at least one database and provide it to the weighting factor synthesis device 260.

Experts 9 may be provided with this database information and asked to make an expert decision as to which of the selected screening practices would have identified this character flow in the disciplined employee before the employee was hired. The number of times a screening practice is indicated to have identified the disciplined employees, the more important that screening practice becomes and the higher the relative weighting factor will be.

Therefore, if “Federal Criminal Background Check (SP₇)” is identified for twice as many disciplined employees as “Motor Vehicle Report (SP₁₀)”, then SP₇ should have a weighting factor (WF₇) that is twice the weighting factor (WF₁₀) as that of SP₁₀. The weighting factor should be proportional to the number of times it was estimated to be the screening practice which would most likely screen out a disciplined employee before he/she was hired.

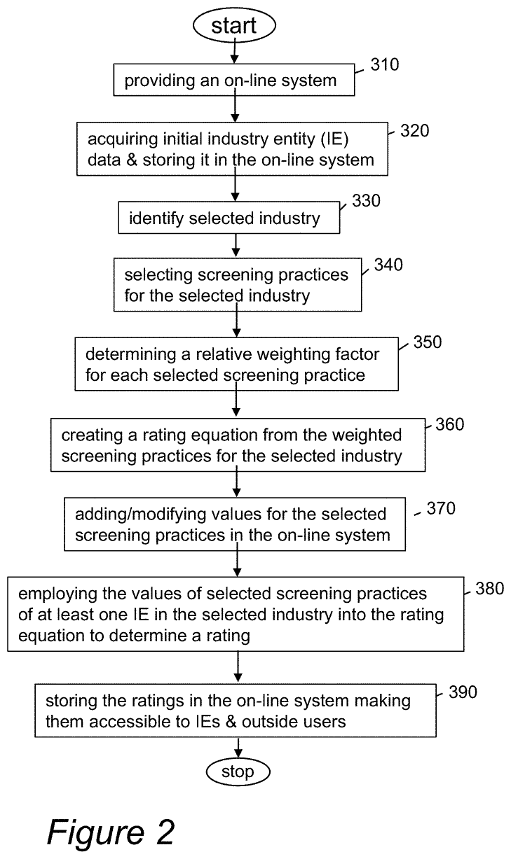

FIG. 2 is a flowchart illustrating the steps of a method of rating the employee screening practices of industry entities (IEs) 3. The functioning of the present invention may be described in connection with FIGS. 1 and 2. An on-line system is provided in step 310.

In step 320, initial information is acquired for each IE 3 from public and private databases. This is general information to set up a record for each IE 3 which may include the name, address, and similar information.

In step 330, the industry that is to be analyzed is identified.

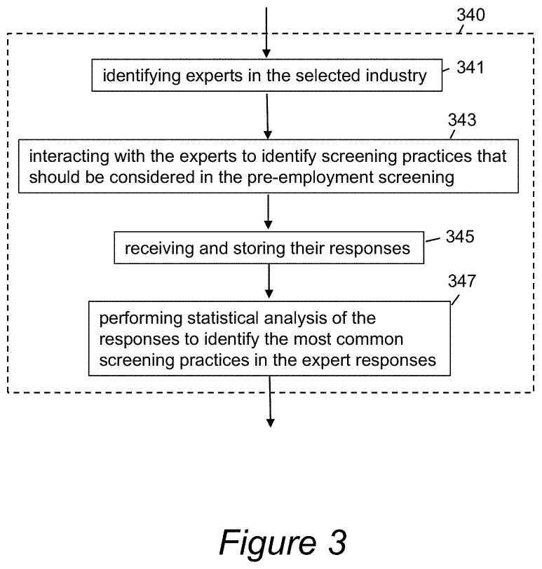

In step 340, the relevant screening practices for this industry are identified and then stored in the parameter storage 130. As indicated above, several different methods may be used, one of which is illustrated in FIG. 3, which will be described later.

In step 350, the weighting factors which identify the relative importance of each screening practice are determined. There are several methods of determining the weighting parameters. One method includes having several experts in the field rate the relative importance of selected screening practices, then performing a statistical analysis, such as average, mean, median, or other known statistical methods to develop the relative weighting factors.

In step 360, a rating equation is created from the selected screening practices and their weighting parameters. At this point most of the initial setup of the system has been completed. The remaining steps generally cover adding information and updating the information and ratings. One method of creating the rating equation is to give a value of “1” for each screening practice that an IE 3 performs to an acceptable level and a “0” for those screening practices that an IE 3 does not perform to an acceptable level.

For example, let us assume that the IEs the system is rating are Home Healthcare facilities. For this industry, it was determined that the relevant screening practices are those listed in Table 1 above.

Table 1 has 20 screening practices (SPs) which include 5 relating to Employment, 11 relating to Background and 4 relating to Drugs. Each SP can be numbered to be screening practice SP₁ at the top down to screening practice SP₂₀ at the bottom. Similarly, the corresponding weighting factors in Table 1 (WF₁, WF₂, WF₃, . . . , WF₂₀) may be numbered in the same manner and such that each corresponding screening practice and weighting factor will have the same subscript, (i.e. SP₅ corresponds to WF₅). Please note that the screening practices may be abbreviated as “(SPs)” and the Weighting Factors may also be abbreviated by “(WFs)”.

Each of the screening practice values (SP₁, SP₂, SP₃, . . . , SP₂₀) is then multiplied by its corresponding weighting factor (WF₁, WF₂, WF₃, . . . , WF₂₀) to create intermediate factors (SP₁WF₁, SP₁WF₁, , SP₁WF₁, . . . , SP₂₀WF₂₀). All of the intermediate factors are summed to get result in a rating for this IE.

Rating=(SP₁WF₁+SP₂WF₂+SP₃WF₃+ . . . SP₂₀WF₂₀) (Eq. 1)

As indicated above, for example, if a screening practice “7. Federal Criminal Background Check (SP₇)” is not being performed by the IE being rated, or is not being performed to an acceptable level, in the embodiment described above, it will receive a “0” value (SP₇=0). As shown in table 1, the weighting factor (WF₇) for this screening practice is “10”; however, the corresponding intermediate factor is “0” (SP₇WF₇=0).

On the other hand, if screening practice “7. Federal Criminal Background Check (SP₇)” is being implemented by the IE to an acceptable level, then it receives a “1” (SP₇=1). Since WF₇=10, the corresponding intermediate factor is then “10” (SP₇WF₇=10).

The intermediate factors are then calculated for all screening practices considered for this industry, then summed to result in the final rating for the IE. The 20 weighting factors (WF₁, WF₂, WF₃, . . . , WF₂₀) of Table 1 sum to “100”. Therefore, if an IE employs all the screening practices of Table 1 to an acceptable level, it would result in a rating of “100”. If none of these screening practices are not being used to an acceptable level, the rating is “0”. Therefore, the rating range is from “0”-“100”.

### Normalization

If there are more or fewer screening practices, and/or the weighting factors do not total “100”, the weighting factors may be normalized. This is done by assuming the maximum rating, in which an IE implements all screening practices to an acceptable level. Let us assume that the total of all of the weighting factors is “167”. Then each weighting factor is multiplied by a normalization factor of “100/167” to normalize the rating to a maximum of “100”.

The rating can be normalized to any maximum rating number by using the appropriate normalization factor. The numerator will be the desired maximum rating (Rₘₐₓ) and the numerator will be the actual sum of all weighting factors (WF₁+WF₂+WF₃+ . . . WF₂₀). Therefore, it is:

Normalization factor=(Rₘₐₓ)/(ΣWFᵢ) (Eq. 2)

where i=1−n, where “n” is the number of weighting factors.

In step 370, the IEs 3 are then allowed to access the IE storage 110 and request information about themselves. If there is no entry for this IE 3, it is allowed to provide information to request that a record be created for it. The IE 3 is then allowed to suggest additions or changes to the information in the record of IE storage 110. This information includes an indication of the selected screening practices (SPs) identified to be relevant for this industry that are being implemented by the IE. In one embodiment, the values of the screening practices are binary to be objective. The values indicate a “1” if the screening practice is being implemented, and a “0” if it is not being implemented.

In an alternative embodiment, this value may be a number between “0” and “1” which indicates the degree that the screening practice (SP) has been implemented, with “1” being fully implemented and “0” being not implemented.

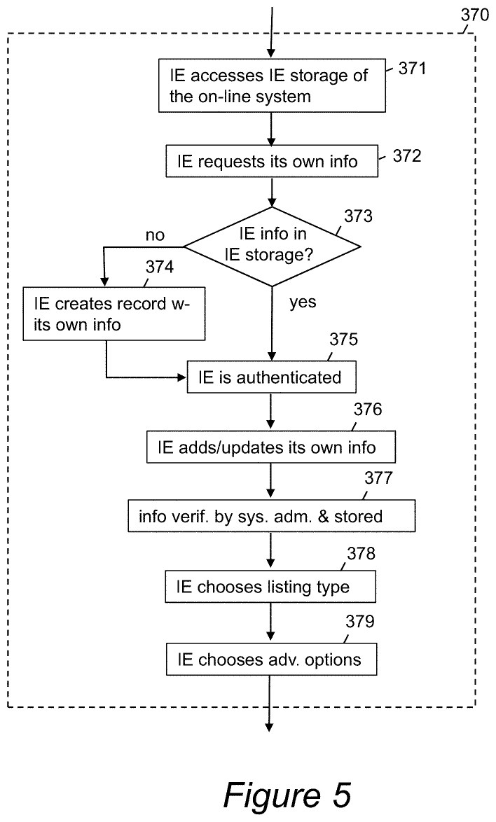

Step 370 is described in a more detailed manner in connection with FIG. 5.

In step 380 the values of screening practices for each IE 3 are entered into the ratings equation to result in the current rating or score.

The rating or score is the sum of the screening practice (SPs) values each multiplied by their corresponding Weighting Factor (WFs) as indicated in Equation (1) above.

In step 390, the ratings are stored in the IE storage 110, making them accessible to users 5, IEs 3 and the system administrator 7.

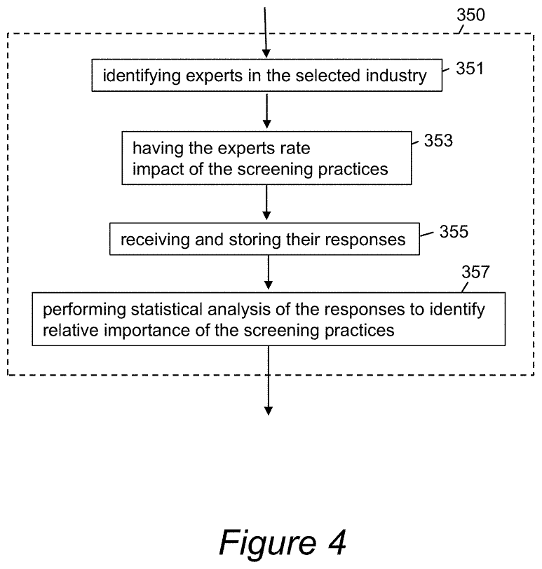

FIG. 3 is a more detailed breakdown of the step 340 of FIG. 2 of selecting screening practices for a selected industry. FIG. 4 will be described with reference to elements of system 100 shown in FIG. 1. In step 341, experts are identified in the industry. In step 343, the parameter selection device 230 of controller 210 interacts with the experts 9 to request their input to determine the screening practices which should be used. These are the screening practices which directly affect the quality of the employee hired.

In step 345, the parameter selection device 230 receives and stores the responses of the experts 9. Their responses are stored in parameter storage 130.

In step 347, the parameter selection device 230 determines the most common screening practices found in the experts' 9 responses. It may perform statistical analyses on the experts' 9 responses to find and only use those that are statistically significant.

FIG. 4 is a more detailed breakdown of the step 350 of FIG. 2 of determining a relative weighting factor for each selected screening practice. FIG. 4 will be described with reference to elements of system 100 shown in FIG. 1. In step 351, experts in the industry are identified. The experts are requested to rate the impact of each selected screening practice in step 353.

In step 355, the weighting factor synthesis device 260 receives and stores the responses of the experts.

In step 357, the weighting factor synthesis device 260 analyzes the responses from the experts and creates weighting factors which weight the selected screening practice based upon their relative impact. This will involve how many experts identified the screening practice and how highly they rated the importance of that screening practice. These are combined to create the weighting factors. A large weighting factor means that the corresponding screening practice is very important in determining a quality employee (one that performs well during employment) in the pre-employment screening.

FIG. 5 is a more detailed breakdown of step 370 of FIG. 2 of adding/modifying values for a selected screening practice. It also mentions parts of the system diagram of FIG. 1.

Once the screening practices are selected, the weighting factors are determined, and the rating equation has been constructed, the system may be operated. FIG. 5 identifies the steps involved with an IE 3 logging into the IE storage 110 and updating its own information.

In step 371, the IE 3 accesses the on-line system 100. The IE 3 may search through records of many different IEs 3 and view their records.

In step 372, the IE 3 may also request information on itself. In step 373, it is determined if the record is present in IE storage 110 for the requesting IE 3. If its record is not present, the IE is given a chance to build a record in step 374. Once it is completed, processing continues at step 375.

If the record was found in step 373, then the record is presented to the IE 3 and processing continues at step 375.

In step 375, the IE 3 is authenticated. This may be by any currently known means of authentication. It may be passwords, biometrics, or use of additional security devices.

In step 376, the IE 3 is allowed to enter information or submit modifications to existing information in its own record.

This information is verified in step 377 by the system administrator 7, and if it verifies correctly, it is entered into IE storage 110.

Since the IE 3 is now interacting with the system, it can also optionally indicate a free basic listing, or opt for a more detailed listing for a small fee in step 378.

In step 379, the IE 3 is given the opportunity to choose different advertising options, wherein the more advanced advertising is provided for a fee. One such choice would be to select a free listing, an enhanced listing, or a premium listing. The features of each of these choices is shown in Table 2 below:

TABLE 2

| FREE LISTING | ENHANCED LISTING | PREMIUM LISTING |
|---|---|---|
| C-Screen Profile | C-Screen Profile | C-Screen Profile |
| & Score | & Score | & Score |
| Company Name | Company Name | Company Name |
| | Company Address | Company Address |
| | Company Phone | Company Phone |
| | Company URL | Company URL |
| | | Company Images & Videos |
| | | Company Description |

### Alternative Embodiments

Different industries would be more sensitive to different employee traits and would require different screening requirements. For example, the pharmaceutical industry would be sensitive to employees having criminal records relating to drug abuse. Therefore, the employee screening procedures selected for screening employees in this industry would have more stringent or additional drug screening procedures.

Similarly, child care centers would be more sensitive to screening out applicants for employment that indicate a propensity to misbehavior relating to children. This may have more stringent or additional employee screening practices relating to sexual crimes with children, or physical abuse of children. Therefore, each industry (and possibly sub-industry) may employ different employee screening practices which may be determined to be included under the spirit of the current application.

The rating or score described above for an IE 3 rated by the system of the current application, can be expressed a single scalar number, or can be expressed in terms of one or more of the intermediate calculations used to arrive at the final score. For example, the score may be expressed along with one or more subscores for different categories of the employee screening practices used to determine the final score.

Any of the scores may be expressed as coded colors with a spectrum from low to high. They may be categorized into segments of the overall score range or expressed in any currently known method for indicating ratings.

In another embodiment of the current system, a user or IE 5 can request additional information for an additional charge. For example, the basic information identifying an IE 5 is made available, along with the final score (rating). For a small fee, this score may be broken down into its component scores for different subcategories of the employee screening practices to more clearly study the scores of the subcategories. This may lead to a better understanding of the employee screening practices of the subject IE 3.

Other capabilities may exist such as the ability to analyze screening practices across the entire database. For example, it will be possible to determine which, of the total set of IEs 3, does or does not perform a driving record check.

Additional abilities could be implemented in the system of the current application, such as time tagging information to acquire a time dimension. For example, the IEs 3 will be expected to enter the date which they began to implement each of their employee screening practices. A default date could be the date that they enter the information into the system which could be updated to reflect the actual date they had implemented the practice. This can give an indication of how an IE 3 supplemented their employee screening practices over time to the present time.

The system may also implement a score history. This will store the various scores for an IE 3 as the score changes over time. One may look at the history of the IE 3 to see the advancements it has made over time and the continual increase in score. This is particularly important to an IE 3 which had a low score that has worked to improve its score over continuous improvement.

### 5-Star Rating System

It is more recognizable and inherently easier to view and compare star ratings as opposed to numerical ratings. For example, numbers may be converted to a 5-star rating system where each star represents 20%. Therefore a 5-star rating=100%. Therefore, all ratings are converted to a percentage being a score divided by the maximum score obtainable. This results in a number from 0 to 1, where 1=100%. This may be rounded off to the nearest half-star with each half-star being 10%. Therefore 4 and ½ stars would equal 90%.

As indicated above, the process a company uses to choose its employees is very important to how it functions. However, there are other aspects of a company that go to the core values of the company, such as the integrity of the upper management. Theoretically, they are the decision makers and set the direction and processes in place. Therefore, it is also valuable to know how the management has acted in the past to provide to potential customers.

The goal is to use publicly-available information to minimize the subjective nature of the report or rating. The research is limited to the executive management, who are the decision makers.

### Management—CRIMINAL BACKGROUND CHECK

It may cover criminal background checks on the executives. The a) number of offenses, b) severity of each offense; and b) recentness of each offense are considered in determining a rating for past crimes.

a) Number of Offenses

The rating may take into account all of the offenses above a certain level of seriousness. These will be accumulated as part of the rating.

b) Severity of the Offense

Each offense may have a severity based upon the actual sentence or fine, the sentence/fine suggested in applicable sentencing guidelines (state or federal). These may be used to estimate the relative severity, based upon a given sentence/fine relative to a calculated average sentence/crime for a defined population.

c) Recentness of the Offense

Each offense considered should be weighted with decreasing weight based upon when the offense was committed. This is based upon an assumption that the person being examined may have changed over time.

### Management—CIVIL BACKGROUND CHECK

Similarly, there may be a civil background check, which may indicate bankruptcies, foreclosures, and civil lawsuits. Again, the number, severity, and age of the civil actions are taken into account in determining a rating.

### Management—FINANCIAL BACKGROUND CHECK

In states in which it is allowed, it would also be important to perform a financial background check listing outstanding debts for key management individuals at the company being analyzed. Due to privacy concerns, the actual debts should not be published, but the debts may be compared to an average debt of a similarly positioned individual. For example, a similarly positioned individual will have similar demographics, such as any of age, sex, family size, location, occupation, etc. The rating could be a general rating such as one to five stars, with 5 stars being the best rating, and an average rating being 2.5 stars based upon the outstanding debts. The reason for the financial background check is that an executive's decision may be swayed when one is in dire need of cash, possibly causing damage to the company.

### Management—PREVIOUSLY OWNED COMPANIES BACKGROUND CHECK

Since past performance may be an indicator of future events, it is important to see what companies each of the target managers have owned or controlled before. It is also important to determine how well the company did under the control of the target manger. For example, a rating can be created which considers the company's dollar sales when the target manager was an executive at the company. This may be the dollar sales when the target manager left the executive position of the previous company as compared with the company dollar sales when the target manager started the executive position. This is normalized for the number of levels the target manager was removed from the top position. For example, if there is a company with three management levels and the target manager was the CEO, the multiplier will be 1.0 for the top level. If the target manager was one level removed from the top level, level 2 of 3 levels, the multiplier would be 2/3 or 0.67. This adjusts for the amount of control the target manager has over the company's decisions.

The dollar sales difference during the target manager's tenure should be normalized by the company's average sales for the target employee's tenure.

These numbers can be accumulated going back a predetermined number of years for companies in which the target manager was an executive.

Since many of the parameters reviewed for the target managers are not easily reduced to equivalent scalar numbers, reports or ratings may be given for each of the individual categories discussed above.

Ratings from 3^{rd} Party Sites/Services

Other less objective measures of company management could also be used. Sites and services exist that provide approval ratings of CEOs, or the percentage of current employees that would recommend working for a given company to a friend, such as www.glassdoor.com. The number of consumer complaints can also be an indicator of problems with management of a company. The actual raw numbers must be normalized for the size of the company. One way is to determine consumer complaints per annual income, or consumer complaints per number of employees.

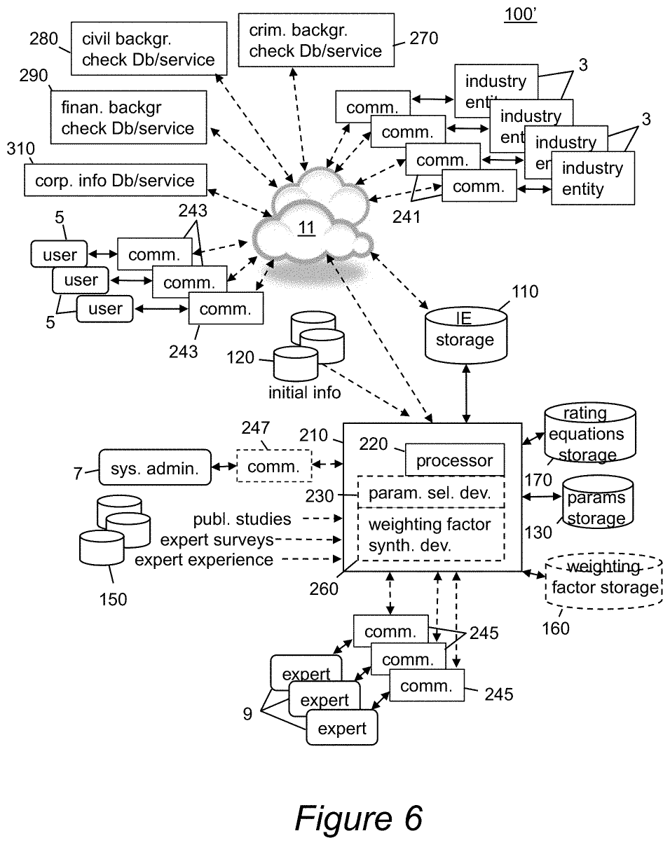

FIG. 6 shows a system diagram of an automated system 100′ according to another embodiment of the current invention. (Elements here will have the same function as those elements with the same number that have been previously shown and discussed.) The system 100′ provides objective information and ratings of the tasks of employee screening practices performed by industry entities (IEs) 3 and adds information regarding the executive management. Again, we assume that the IEs 3 are home health care companies for the home health care industry, or other companies for other industries. This also is an on-line system wherein at least part of it is remotely located and remotely accessible. As above, IEs 3 communicate through IE communication devices 241 through local area network (LAN), wide area network (WAN), Internet, private network, or other inter-computer connection means (collectively referred to as a “computer network”) 11 to an IE storage 110. The IE storage 110 is the main depository of information of the IEs 3, as will be explained further below.

Users 5 are allowed to access, search, and view, but not modify or delete information on the IE storage 110 using user communication devices 243.

As with the system 100 of FIG. 1, the system administrator 7 communicates directly (or through an optional systems administrator communication device 247) with other elements of system 100′ to configure, initialize and otherwise manage the system 100′.

### Selecting Screening Practices

The system administrator 7 interacts through a system administrator communication device 247 with a controller 210 to determine a listing of relevant screening practices for at least one industry covered by the current invention in the same manner as described for FIG. 1. Controller 210 may incorporate a specific device and/or software routines that aid in determining the screening practices to be used. The methods listed above are also used in this embodiment:
identifying the screening practices common to the leading publications in the industry;
statistically identifying the leading reasons for employee dismissal and identifying the screening practices associated with these reasons;
selecting a group of experts in the industry and polling them for the relevant screening practices, then selecting those screening practices that had been proposed by several experts.

In the simple embodiment, an expert 9 in the industry, acting through a communication device 245, communicates with a controller 210 which may employ a processor 220. The expert 9 can simply input the screening practices to be used in the rating process. These screening practices can then be stored in the parameter storage 130.

In another embodiment, controller 210 may include a parameter selection device 230 that may receive published studies in the industry relating to screening practices. The parameter selection device 230, controlled by the system administrator 7, searches for relevant screening practices and analyzes them. The most relevant and/or commonly mentioned screening practices will be stored in the parameter storage 130 and used to rate the IEs.

The parameter selection device 230 may also search published expert surveys dealing with screening practices. These may be digested to provide the few most commonly mentioned screening practices that will be used for rating the IEs 3.

The parameter selection device 230 may also analyze numerous publications dealing with publications of experts' experience in the field, selecting the most commonly mentioned screening practices that will then be stored in the parameter storage 130 and used in rating the IEs' employee screening practices.

In another embodiment it can be arranged that a number of experts 9 log into the automated interactive system 100 through communication device 245. The experts 9 can log in at their leisure over a period of time. The parameter selection device 230 may then interactively send questions to the experts 9 requesting information that would identify screening practices that they believe are relevant. The parameter selection device 230 receives the experts' 9 responses then selects the most commonly mentioned screening practices for use in determining a rating. These screening practices are then stored in the parameter storage 130.

The weighting factors may be determined as described above.

The system 100′ allows the IEs 3 to view the information about them that is currently in the IE storage 110 that is being provided to the public. The IE 3 is allowed to search through the IE storage 110, view records, and provide updated information about its own records in the IE storage 110. The updated information is verified by the system administrator 7. Once it is verified, the information is updated in the IE storage 110.

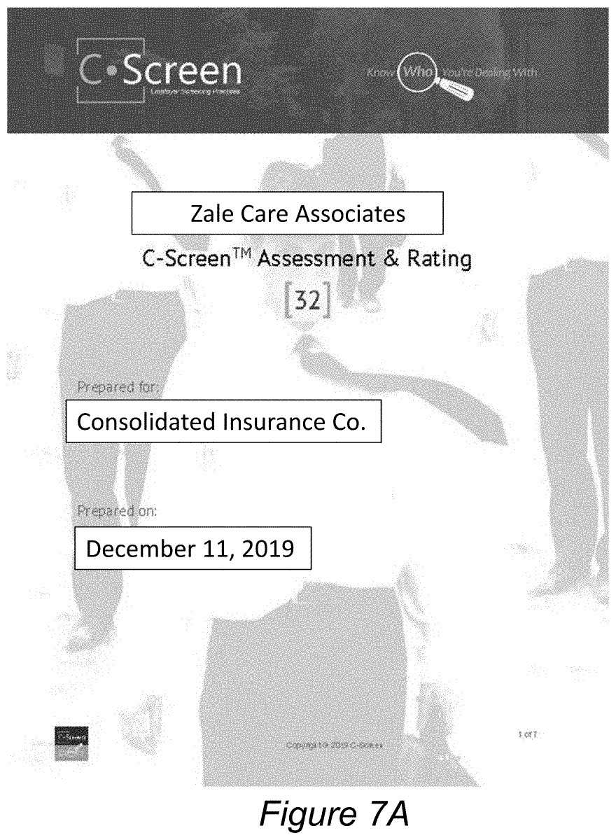

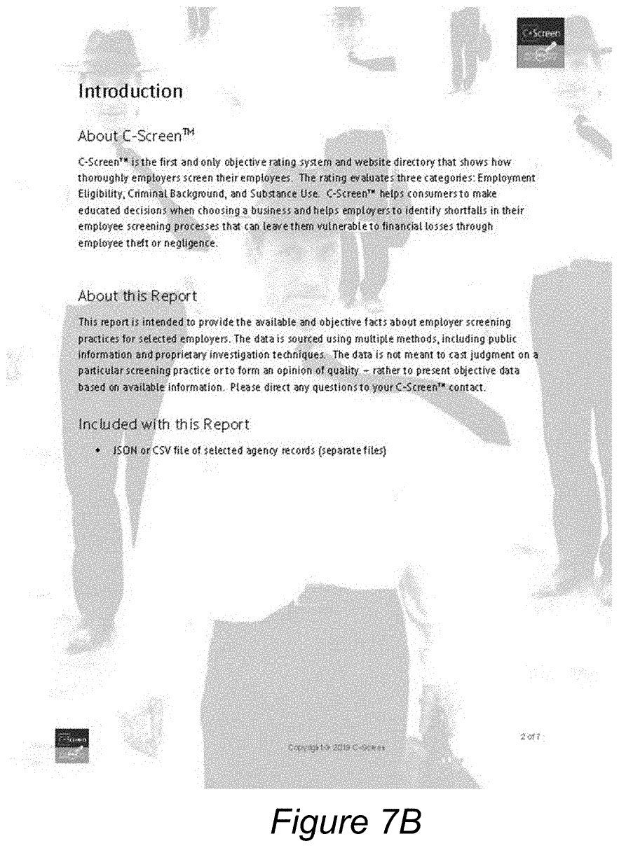

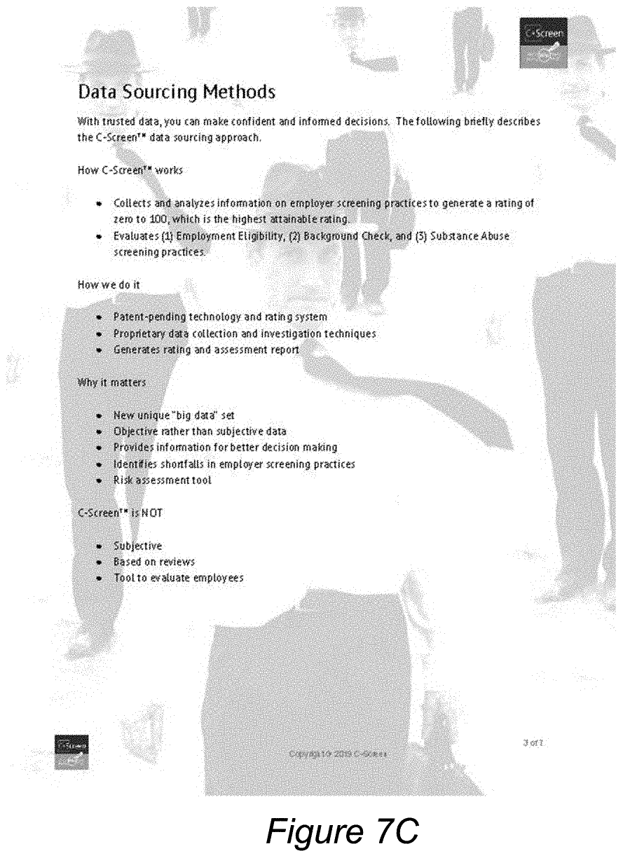

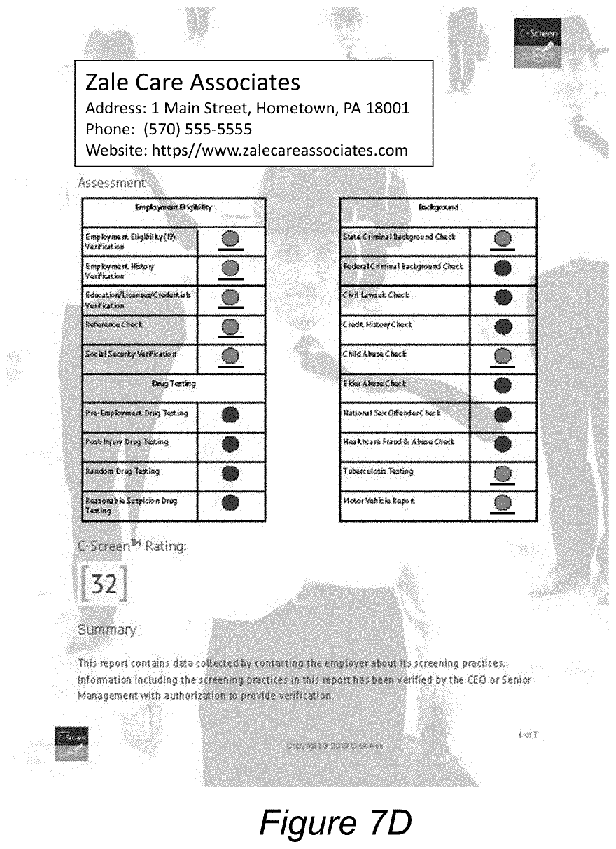

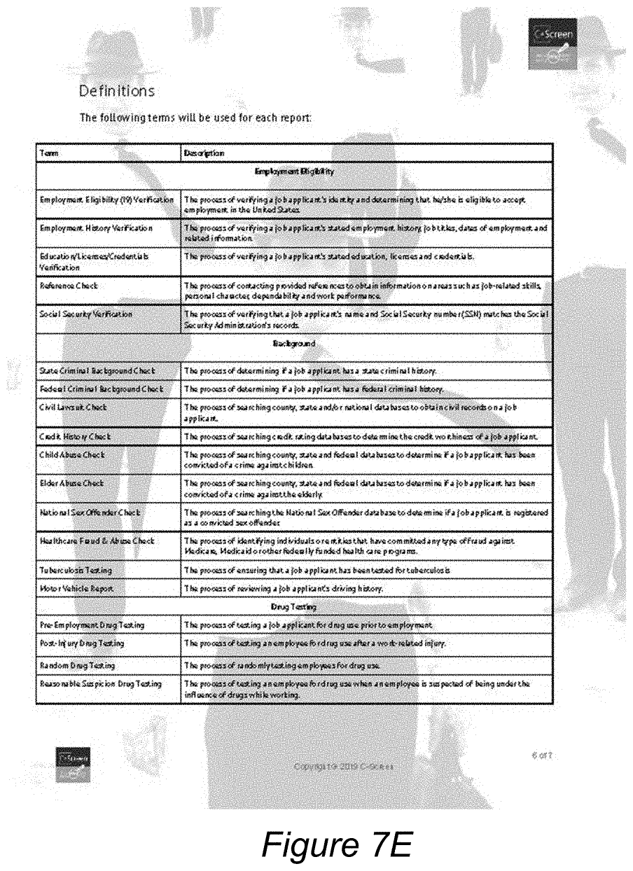

Controller 210 of FIGS. 1 and 6 has the ability to access all elements of the current system and collect information on various IEs 3. A request may be received by controller 210 from an IE 3, a user 5 or the system administrator 7 through their corresponding communication devices 241, 243, 247 to create a report on one or more specific IEs 3. The controller 210 collects the screening practices (SPs), the values for each screening practice, and the IE ratings from their storage devices and generates one or more reports. An example of one of the reports is shown in FIGS. 7A-7E for a fictitious HHC company named “Zale Care Associates”. The screening practices (SPs) used for the Home Healthcare Industry are explained alone with the values of each (here underlined for “performed” or “performed to an acceptable level” and not underlined for “not performed” or “not performed to an acceptable level”. (In at least one embodiment of the current invention, the indicators in the reports would be color coded green for “performed” or “performed to an acceptable level” and red for “not performed” or “not performed to an acceptable level”.)

These are used to create the rating of the IE on a scale from 1-100 with 100 being the best. This IE received a rating of “32”. This is a low rating. More than likely, a potential customer would be reluctant to hire this IE due to its low rating.

FIGS. 7A-7E may be displayed on user communication devices 243 is requested by user 5, IE communication devices 241 if requested by IE 3, or administrator communication device 247 if requested by the system administrator 7. Reports may also be requested one of the communication devices and displayed on another communication device.

It is also possible to print out the report, e-mail it, post it or otherwise share the report.

### Analysis of Executive Management

The theory of this embodiment is that the executive management has significant power and influence over the employees and how they behave. Therefore, an analysis of the executive management will provide significant information on how services are provided. Therefore, each executive analyzed is referred to as a “target manager”.

The processor 220 looks at a record in the IE storage 110 for an IE 3 to determine the top executives. If this information is not available there, the processor 220 then accesses a corporate information database or corporate information service 310 through the web 11. Once the name or other identifying information of the target manager is obtained, processor 220 may perform a criminal background check by accessing Criminal Background check database or service 270 through the cloud 11. Similarly, the processor may then access civil background check database or service 290. This may have information such as past and current litigations, bankruptcies, and other adverse actions.

The processor 220 may then access the financial background check database or service 290 to find information on current and past debts, liens, and other financial information. The processor 220 may also access a corporate database or service to find past companies which the target manager has managed.

All of this information is implemented as indicated above to determine if there are any known items which may affect the target manager's decisions, bias his/her decisions. These may be indicated as a report or reduced to a rating in several categories. Selected portions of this information and/or ratings can be stored in the IE storage 110 for the users 5 to view and for the IE 3 to view and request updates.

This process is repeated for the top executives of an IE 3. The entire process may then be repeated for several of the IEs now resulting in ratings of the thoroughness of the employment process, and information on potential weaknesses of management of an IE 3.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the foregoing aspects are illustrative, and no single feature or element is essential to all possible combinations that may be claimed in this or a later application.

What is claimed is:

1. A system for selecting an industry entity (IE) based upon rating selected screening practices (SPs) of the IEs by a remote user employing a user communication device, comprising:
a controller;
wherein the user communication device is operably connected to the controller;
an IE storage device that can be accessed by a remote user through the user communication device and store, through the controller, values of employer's screening practices of a plurality of Industry Entities (IEs);
a parameter storage device remotely accessible by the remote user through the user communication device having a prestored list of employer's screening practices (SPs) to be used by the controller to determine a rating for a selected industry;
a weighting factor storage device capable of storing weighting factors (WFs) that each indicate an importance of each selected screening practice (SP);
the controller coupled to the IE storage device, the parameter storage device, and the weighting factor storage device, wherein the processor includes a set of instructions that when executed:
acquire a plurality of selected employer's screening practices (SPs) from the parameter storage device;
acquire values of the plurality of selected employer's screening practices from the IE storage device;
acquire corresponding weighting factors (WFs) from the weighting factor storage device 160;
determine a rating for each IE by summing each selected employer's screening practice (SP) value multiplied by its corresponding weighting factor (WF);
electronically transmitting the rating to, and displaying the rating on the user communication device of the remote user; and
selecting, by the remote user, an IE based upon the rating.

2. The system of claim 1 further comprising a plurality of IE communication devices that communicate through the controller with the IE storage device, wherein each IE communication device:
requests from the IE storage device, information the IE storage device has stored relating to its corresponding IE;
stores missing values of the selected screening practices (SPs) relating to its corresponding IE in the IE storage device; and
updates existing values for the screening practices relating to its corresponding IE in the IE storage device.

3. The system of claim 1 further comprising a system administrator communication device that receives input from a systems administrator and provides this input to the controller to select screening practices (SPs) that will be compared in rating each IE.

4. The system of claim 3 wherein values of the selected screening practices (SPs) are stored in the IE storage device.

5. The system of claim 4 wherein the screening practices (SPs) comprise at least one of: verification of past employment, verification of background, and drug screening tests.

6. A system for aiding a remote user in selecting an industry entity (IE) to employ based upon rating of the thoroughness of the screening practices (SPs) of IEs comprising:
a user communication device capable of receiving user input and communicating with remote computing devices;
a controller capable of communicating with the user communication device;
a parameter storage device having prestored selected screening practices (SPs) relevant to the current industry;
a weighting factor storage device capable of storing weighting factors (WFs) indicative of the importance of each of the selected screening practices (SPs);
an IE storage device capable of storing values for each of the selected screening practices (SPs) for each IE;
wherein the controller includes a set of instructions that when executed receives the selected screening practices (SPs) from the parameter storage device, the corresponding values for each selected screening practice (SP) from the IE storage, and the weighting factors (WFs) for each of the selected screening practice (SP) from the weighting factor storage device, multiplies the value for each screening practice (SP) by its corresponding weighting factor (WF) to create products for all selected screening practices (SPs), and sums all products to create a rating for each IE, and provides the ratings to the user communication device to display to the user aiding the user in selecting and hiring an IE.

7. The system of claim 6 wherein the weighting factor indicates the relative impact of the selected employer's screening practice upon a quality measurement of an employment process of an IE.

8. The system of claim 6 wherein the values in the IE storage device are populated by the IEs interactively using IE communication devices.

9. The system of claim 6 wherein the selected screening practices are at least one of the group consisting of: verification of past employment, verification of background, and drug screening test results.

10. The system of claim 9, wherein the selected screening practices relating to the verification of past employment further comprise at least one of the group consisting of: employment eligibility (I9) verification, employment history verification, education verification, license verification, credentials verification, reference check, and social security verification.

11. The system of claim 9, wherein the selected screening practices relating to the verification of background further comprise at least one of the group consisting of: state criminal background check, federal criminal background check, civil lawsuit check, credit history check, motor vehicle report, child abuse check, elder abuse check, national sex offender check, excluded parties list system (EPLS) check, list of excluded individuals/entities (LEIE) check, and tuberculosis testing.

12. The system of claim 9, wherein the selected screening practices relating to the verification of drug screening test results further comprise at least one of the group consisting of: pre-employment drug testing, post-injury drug testing, random drug testing, and reasonable suspicion drug testing.

13. A system to objectively create and publish a rating of employment screening practices (SPs) of industry entities (IE) to a user aiding the user in hiring an IE, comprising:
a parameter storage device having a plurality of pre-stored employment screening practices (SPs) which are relevant to a given industry;
a weighting factor storage device for storing weighting factors (WFs) each indicating a relative importance with each associated selected screening practice (SPs);
an IE storage device for storing a value for each selected screening practices (SPs) indicating those screening practices (SPs) that are currently being performed by each of the IEs;
industry entity communication devices coupled to the controller, which communicate information between Industry Entities (IEs) and the IE storage device through the controller;
wherein the controller multiplies each of the (WFs) in the weighting factor storage device 160 by the values of their corresponding (SPs) in parameter storage device 170 and sums these products for all selected screening practices (SPs) to result in the rating of each IE that is stored in the IE storage device, that is used by user to hire an IE.

14. The system of claim 13 wherein the weighting factor synthesis device 260 creates weighting factors based upon survey data of experts in the field.

15. The system of claim 13, wherein the weighting factor synthesis device creates weighting factors (WFs) based upon a database having a listing of persons that were disciplined and reasons for the discipline of each person.

16. The system of claim 13, wherein the weighting factor synthesis device creates weighting factors based upon published articles indicating the relative importance of various screening practices.

17. The system of claim 13, further comprising:
at least one industry entity communication device that communicates through the controller with the IE storage device allowing the industry entity communication device of an IE to read, change or delete its own information on IE storage device.

18. The system of claim 13, further comprising:
at least user communication device 243 that communicates through the controller with the IE storage device allowing the user communication device 243 to read information of the IEs on IE storage device.

19. The system of claim 13, wherein the controller further comprises:
a parameter selection device 230 coupled to the parameter storage device 170, that receives input from the system administrator 7, selects screening practices (SPs) relevant to a selected industry and stores the selected screening practices in the parameter storage device 170.

20. The system of claim 13 wherein the controller comprises:
a weighting factor synthesis device 260 that receives input relating to a relative importance of each of the selected screening practices (SPs) and generates weighting factors (WFs) for each of the selected screening practices (SPs) indicating their relative importance and stores them in the weighting factor storage 160.
